(19) United States
(12) Patent Application Publication
(10) Pub. No.: US 2020/0342530 A1
(43) Pub. Date: Oct. 29, 2020

(54) DYNAMIC ASSET PACKAGE AND METHODS FOR USING A DYNAMIC ASSET PACKAGE FOR ENSURING ASSET PACKAGE QUALITY FOR SECURITIZATION

(71) Applicant: Rose Logic Inc., San Francisco, CA (US)

(72) Inventors: Shao Kang ZHU, Beijing (CN); Gu CHEN, Shanghai (CN); Jun BIAN, Beijing (CN); Keith WENG, Redwood City, CA (US)

(21) Appl. No.: 16/397,317

(22) Filed: Apr. 29, 2019

(51) Int. Cl. G06Q 40/04; G06Q 20/38

(52) U.S. Cl. CPC G06Q 40/04; G06Q 20/389

(57) ABSTRACT

A method for combining a dynamic asset package with a pool of assets prevents problems and reduces risks with asset-backed securities. The dynamic package can support removing and replacing an individual asset so that problematic assets can be replaced, thus maintaining asset package value transparently. Updates to the asset package can be recorded on the blockchain to prevent tampering. With an appropriately maintained extensive pool of assets, the methods can provide good candidates available to replace bad assets in various packages, allowing the reliable maintenance of packages at the expected quality. The pool of assets and the asset packages can be managed such that the expected flow of new assets will be sufficient to maintain the quality of the defined packages. The resulting dynamic asset package will be of good quality and the risks will be much lower than that found in conventional static asset packages.

### BACKGROUND OF THE INVENTION

### 1. Field of the Invention

Embodiments of the invention relates generally to financial technologies. More particularly, the invention relates to methods for building a blockchain of assets for asset-backed digitization and securitization (ABDS). The assets may include any security that is based on transparent data and monitoring and which may be put onto blockchain.

### 2. Description of Prior Art and Related Information

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

There are many assets in many industries that have not been securitized in the past or, if securitized, there exists significant flaws that limit profit and adoption. In many industries, the enterprise may have many good assets, but it is difficult to raise funding because investors have no way to know the assets and verify the authenticity of the assets. If the enterprise is a strong corporation or has strong credit, it may have ways to secure financing or issue asset-backed securities. However, for small and medium-sized enterprises, they may have no way to do the financing from a public market, such as with asset-backed securities.

Currently, only about three percent of assets in the global economy are suitable for securitization via asset-backed securities, resulting in a severe limit to the asset-backed securities market. Previously, assets for asset-backed securities were presented in static form, such as in a PDF file or in an Excel file. The static information could not show the current status of the assets and it is difficult to verify the truth of the content of such static files.

The manner in which some markets record assets in an asset-backed security business has several downsides that can increase risk. For example, the assets are recorded statically, meaning that the set of assets in an asset-backed security package is fixed. This means that any deterioration of individual asset value reduces the overall package value. This also means that any incorrect recording can result in errors, inaccuracies or even incompatible assets being included in the package, affecting the value of the whole package. Moreover, the assets are typically recorded in Excel files, where maintaining the files can be error-prone and vulnerable to falsification. As a result, there are substantial hard-to-monitor risks in conventional asset-backed securities.

In the auto loan industry, funding is the major limit on growth of the business. Many auto loan companies have a lot of good assets, but they have difficulty raising funding because investors have no way to assess the assets and verify the authenticity of the assets. If the auto loan company is a strong corporation or has strong credit, it may have a way to do financing or issue asset-backed securities (ABS). However, in China for example, there are thousands of auto loan corporations, of which less than ten corporations have strong credit. That means most auto loan corporations cannot issue ABS to get financing, even though auto loan assets are usually good for asset-backed securitization. Auto loans typically have the vehicle as collateral and the asset quality is typically high enough to reduce the risk of a few bad assets that would otherwise cause the whole ABS failure. Therefore, auto loans should be capable of asset-backed securitization, however there currently lacks methods for verifying loan assets so that they are accepted as sufficient for funding.

In the utility infrastructure industry, funding is the major limit on growth of the business. Many large infrastructure development companies have good projects and assets, but they have difficulty raising funding from public market because investors have no way to assess the assets and verify the authenticity of the assets.

In the real estate industry, lack of funding is the major limit on growth of the business, especially funding based on future or prospective cash flows. Many real estate companies have a lot of good assets, but they have difficulty raising funding because investors have no way to assess the assets and verify the authenticity of the assets. If the real estate company is a strong corporation or has strong credit, it may have a way to do financing or issue ABS. However, most real estate corporations are small or medium sized, which have difficulty issuing ABS to get financing even though real estate future cash flow assets are usually good for ABS. Furthermore, large real estate corporations are also facing financing issues because of rapid new business growth. Real estate future cash flow assets have the real estate as the collateral and the asset quantity is high enough to reduce the risk of a few bad assets causing failure of the whole ABS. Thus, real estate future cash flow or prospective earning assets should be good for ABS, however, real estate future cash flow assets cannot be verified and be accepted as sufficient for funding.

In the supply chain industry, suppliers' funding is the major limit on growth of the business. Many supplier companies have a lot of good account receivable assets, but they have difficulty raising funding because investors have no way to assess the assets and verify the authenticity of the assets. If the supplier company is a strong corporation or has strong credit, it may have a way to do financing or issue ABS. However, most suppliers are small or medium sized, which have difficulty issuing ABS to get financing even though supplier account receivable assets are usually good for ABS. Furthermore, large supply chain corporations are also facing financing issues because of rapid new business growth. Supplier account receivable ABS has the core supply chain corporation as the collateral, and the asset quantity is high enough to reduce the risk of a few bad assets causing failure of the whole ABS. Thus, supplier account receivable assets should be good for ABS, however, supplier account receivable assets cannot be verified and be accepted as sufficient for funding.

In view of the foregoing, it is clear that there is a need for systems and methods for building an assets blockchain, digitizing assets for uploading to the blockchain and providing dynamic asset packages in order to overcome several of the issues of conventional systems as presented above.

### SUMMARY OF THE INVENTION

Embodiments of the present invention provide a dynamic asset package comprising a plurality of assets forming an asset package; and an asset pool of assets, wherein an asset of the asset package is replaced with an asset of the asset pool when the asset of the asset package is determined to be problematic; and each of the plurality of assets are stored on a blockchain.

In some embodiments, the asset pool of assets has a quality similar to the plurality of assets in the asset package.

In some embodiments, each of the plurality of assets forming the asset package and each of the assets of the asset pool are screened according to one or more conditions.

In some embodiments, verified data regarding each of the plurality of assets is recorded on the blockchain.

In some embodiments, assets from the asset pool that replace assets in the asset package are recorded on the blockchain for transparency.

Embodiments of the present invention further provide an asset packaging process comprising creating an asset in a particular industry; storing the asset on a blockchain; creating an asset pool from a plurality of the assets; screening the plurality of assets based on criteria to create screened assets; and creating an asset package from at least a portion of the screened assets.

In some embodiments, the process further includes retaining at least a portion of the screened assets as a non-packaged asset pool. In some embodiments, the process further includes managing the asset package to maintain a value thereof. In some embodiments, this management includes replacing a problematic asset in the asset package with an asset from the non-packaged asset pool.

In some embodiments, the process further includes electronically verifying data related to the assets and storing data reflecting the verification of the assets on the blockchain.

In some embodiments, the process further includes issuing an asset-backed security based on the asset package.

Embodiments of the present invention further provide a method for building a dynamic asset package comprising establishing an asset pool comprising a plurality of assets, wherein data collected on each of the plurality of assets are recorded on a blockchain to digitize each of the plurality of assets; screening each asset of the plurality of assets in the asset pool based on criteria to create a plurality of screened assets; placing at least a portion of the plurality of screened assets into the dynamic asset package; and maintaining the dynamic asset package to maintain asset quality.

In some embodiments, the step of maintaining the dynamic asset package includes replacing problematic assets in the dynamic asset package with assets selected from the plurality of screened assets.

In some embodiments, the method further includes verifying data collected on each of the plurality of assets. In some embodiments, the additional data associated with the verification of data collected on each of the plurality of assets is recorded on the blockchain.

These and other features, aspects and advantages of the present invention will become better understood with reference to the following drawings, description and claims.

### BRIEF DESCRIPTION OF THE DRAWINGS

Some embodiments of the present invention are illustrated as an example and are not limited by the figures of the accompanying drawings, in which like references may indicate similar elements.

FIG. 1A illustrates operation of conventional ABS public markets;

FIG. 1B illustrates a pictorial representation of how prior methods are not able to provide assets for securitization;

FIG. 2A illustrates operation of an ABS public market available to small and medium-sized businesses via methods according to exemplary embodiments of the present invention;

FIG. 2B illustrates how the methods of the present invention can transform various industry assets into strong assets suitable for ABS;

FIG. 2C illustrates, contrary to FIG. 1B, how methods of the present invention use blockchain technology to reorganize and deconstruct all assets and digitize assets, allowing assets the ability to be securitized;

FIG. 3 illustrates how the methods of the present invention help enterprises pack assets and issue ABS, according to exemplary embodiments of the present invention;

FIGS. 4A and 4B illustrate how, through penetration of underlying auto loan assets, multiple assets can be verified and used to complete asset chains, according to exemplary embodiments of the present invention;

FIG. 5 illustrates a method for asset packaging according to an exemplary embodiment of the present invention;

FIG. 6 illustrates a flow chart showing asset monitoring and replacement to ensure dynamic asset safety, according to an exemplary embodiment of the present invention;

FIG. 7 illustrates the direct repayment from the asset borrower to the prescribed regulatory account to ensure the safety of the fund, according to an exemplary embodiment of the present invention;

FIG. 8 illustrates an asset packaging operation according to an exemplary embodiment of the present invention;

FIG. 9 illustrates how, through professional customized mobile terminals, the methods of the present invention provide mobile exhibition industry transaction cloud platform for financial and other high-end service enterprises;

FIG. 10 illustrates an exemplary operation of a mobile cloud platform for sales of financial products, according to an exemplary embodiment of the present invention;

FIG. 11 illustrates a workflow showing a bank processing of a consumer loan application according to an exemplary embodiment of the present invention;

FIG. 12 illustrates a digital asset blockchain ecological platform architecture according to an exemplary embodiment of the present invention;

FIG. 13 summarizes exemplary method steps involved in various embodiments of the present invention;

FIG. 14 illustrates how blockchain technology reorganizes and deconstructs all assets, links the raw data onto the chain and provides reliable asset data, according to exemplary embodiments of the present invention;

FIG. 15 illustrates an overview for using a blockchain to manage a future rental assets package, according to an exemplary embodiment of the present invention; and

FIG. 16 illustrates a blockchain financial technology solution for supply chains, according to an exemplary embodiment of the present invention.

Unless otherwise indicated illustrations in the figures are not necessarily drawn to scale.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE PREFERRED EMBODIMENTS AND BEST MODE OF INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary, a variety of optional components are described to illustrate the wide variety of possible embodiments of the present invention.

A “computer” or “computing device” may refer to one or more apparatus and/or one or more systems that are capable of accepting a structured input, processing the structured input according to prescribed rules, and producing results of the processing as output. Examples of a computer or computing device may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

“Software” or “application” may refer to prescribed rules to operate a computer. Examples of software or applications may include: code segments in one or more computer-readable languages; graphical and or/textual instructions; applets; pre-compiled code; interpreted code; compiled code; and computer programs.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software program code for carrying out operations for aspects of the present invention can be written in any combination of one or more suitable programming languages, including an object oriented programming languages and/or conventional procedural programming languages, and/or programming languages such as, for example, Hypertext Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Go, Java™, Jini™, C, C++, Smalltalk, Python, Perl, UNIX Shell, Visual Basic or Visual Basic Script, Virtual Reality Markup Language (VRML), ColdFusion™ or other compilers, assemblers, interpreters or other computer languages or platforms.

Computer program code for carrying out operations for aspects of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). The program code may also be distributed among a plurality of computational units wherein each unit processes a portion of the total computation.

The Internet is a worldwide network of computers and computer networks arranged to allow the easy and robust exchange of information between computer users. Hundreds of millions of people around the world have access to computers connected to the Internet via Internet Service Providers (ISPs). Content providers (e.g., website owners or operators) place multimedia information (e.g., text, graphics, audio, video, animation, and other forms of data) at specific locations on the Internet referred to as webpages. Web sites comprise a collection of connected, or otherwise related, webpages. The combination of all the web sites and their corresponding webpages on the Internet is generally known as the World Wide Web (WWW) or simply the Web.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed general purpose computers and computing devices. Typically, a processor (e.g., a microprocessor) will receive instructions from a memory or like device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random-access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASHEEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G, 4G and the like.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory or may be communicated to an external device so as to cause physical changes or actuation of the external device.

Broadly, embodiments of the present invention provide a method for using blockchain technology to ensure the authenticity of auto loan assets. The method further includes packing the assets to form a digital asset package that meets certain conditions. The asset package, also referred to as an asset-backed security, may be exchanged based on the up to date condition of the asset package. Methods of the present invention further ensure the authenticity of transactions so that the data cannot be tampered with. The methods described herein can open the door of financing from public offering markets to small and medium-sized enterprise and help these enterprises to use asset-backed securitization to solve their financing issues.

Through the methods of the present invention, using blockchain technology to penetrate the underlying real auto loan assets, the investors can clearly see the detail and the process of each auto loan business. This can make the asset package a reliable, managed-risk support for financing, thus solving a major issue of financing for auto loan companies, providing means for significant expansion of the auto loan industry.

Further, through the methods of the present invention, using blockchain technology to penetrate the underlying real utility infrastructure assets, the investors can clearly see the detail and the process of each utility infrastructure business. This will make the asset a reliable, managed-risk support for financing, thus solving a big issue of financing for utility infrastructure companies, providing means for significant expansion of the utility infrastructure industry.

Additionally, through the methods of the present invention, using blockchain technology to penetrate the underlying real estate prospective earning assets, the investors can clearly see the detail and the process of each real estate prospective earning business. This can make the asset package a reliable, managed-risk support for financing, solving a big issue of financing for real estate prospective earning companies, and enabling significant expansion of the real estate industry.

Moreover, through the methods of the present invention, using blockchain technology to penetrate the underlying supplier account receivable assets, the investors can clearly see the detail and the process of each supplier account receivable business. This can make the asset package a reliable, managed-risk support for financing, solving a big issue of financing for supplier companies, and enabling significant expansion of the supply chain industry.

According to further embodiments of the present invention, a method is provided to create the assets for digitization and upload on the blockchain. Credit verification of assets may include various steps, including public records and verification via other platforms, utilizing multiple cross-checks as available. This verification data may be stored in blocks and put on the blockchain. Through these methods, embodiments of the present invention can deliver strong and safe digitized assets with real, highly transparent and authoritative public trusted data that cannot be tampered with. Through the methods of the present invention, it can be expected to increase the current three percent of assets that are suitable for securitization via asset-backed securitization to upwards of thirty percent.

Physical assets can be difficult to put on the blockchain, while digital assets are relatively easy to put on the blockchain. One challenge addressed by embodiments of the present invention is to show with trust that the digital asset is a real and true asset before it is placed on the blockchain and to know that its status is accurate. Embodiments of methods of the present invention can reflect the whole process related to the asset in the blockchain. The methods can also support an ongoing flow of dynamic information about the asset to much better reflect its current value. Details of these embodiments are described in greater detail below.

According to additional embodiments of the present invention, a method is provided to combine a dynamic asset package with a pool of assets to prevent problems and reduce risks with asset-backed securities. The dynamic package can support removing and replacing an individual asset so that problematic assets can be replaced, thus maintaining asset package value transparently. Updates to the asset package can be recorded on the blockchain to prevent tampering. With an appropriately maintained extensive pool of assets, embodiments of the present invention can reliably have good candidates available to replace bad assets in various packages, allowing the reliable maintenance of packages at the expected quality. The pool of assets and the asset packages can be managed such that the expected flow of new assets will be sufficient to maintain the quality of the defined packages. As long there is new business, generating new assets will be continuously added, so that the asset pool with contain new good assets, the dynamic asset package will be of good quality, and the risk for securitization will be much lower than that found in conventional static asset packages.

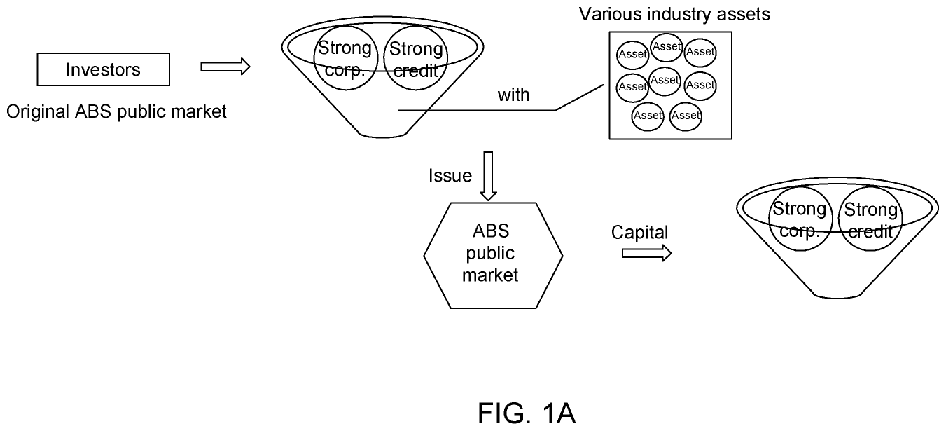

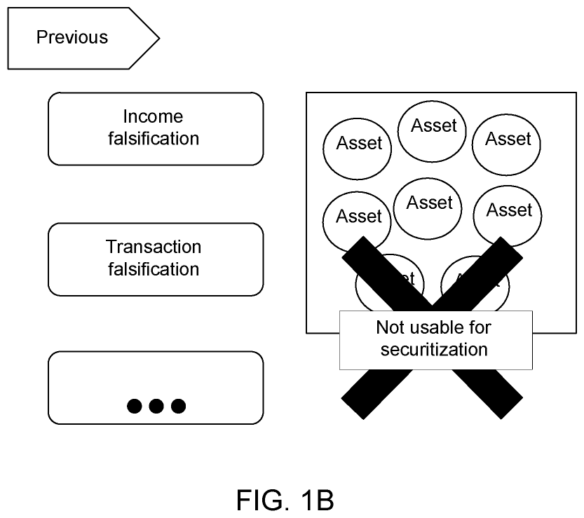

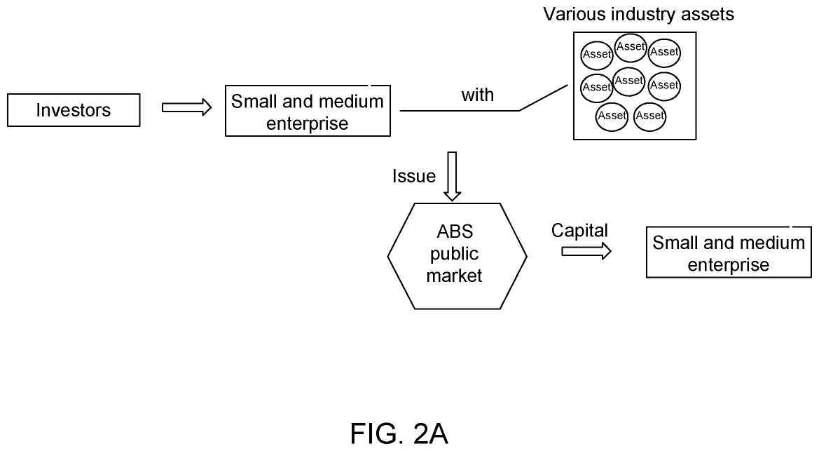

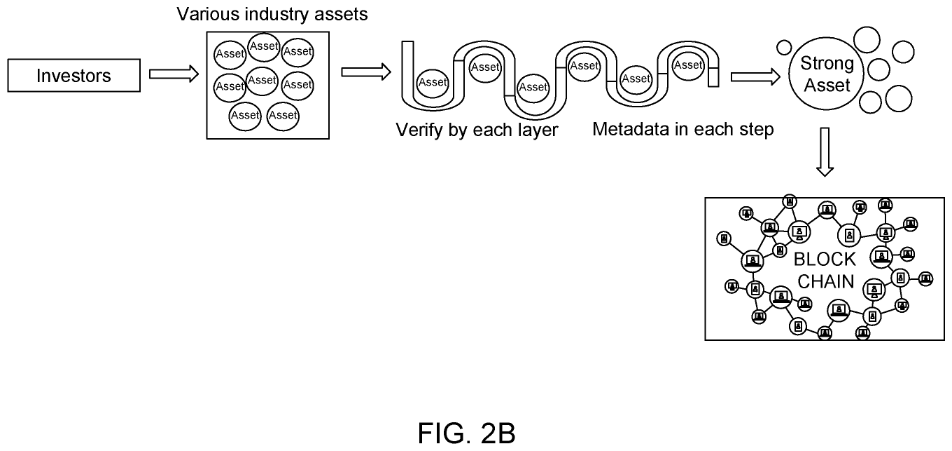

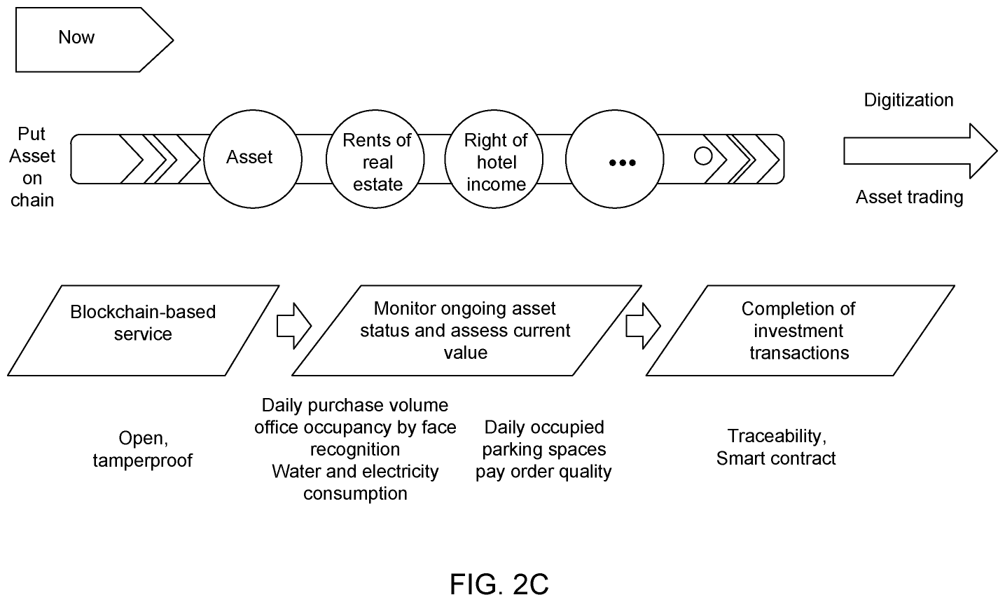

Referring to FIGS. 1A and 1B, there is shown a conventional use of the asset-backed securitization markets, where strong companies with strong credit, having industry assets may market their assets on public asset-backed security markets. Many small and medium-sized enterprises, however, face problems where they do not have the reputation necessary to issue asset-backed securities to generate capital. As discussed in greater detail below, embodiments of the present invention provide the use of blockchain technology, as shown in FIG. 2A to realize the transformation from the strong corporation/strong credit model of FIG. 1A to a strong asset model for the issuance of asset-backed securities.

FIG. 2B illustrates a schematic representation of the asset-backed securitization (ABS) public market as available through methods according to embodiments of the present invention. By relying on methods of the present invention, as described in greater detail below, the methods can penetrate the detailed tracking data about the assets, thus filtering down to the true, effective, trusted and reliable assets to create a strong asset set that may be traded on the ABS public market.

FIGS. 1B and 2C summarize and compare conventional financial technology to that achievable with embodiments of the present invention. Previously, there were many issues with assets, especially those from small and medium-sized companies, or those companies with little or no credit, newly established companies, or the like. These issues include income falsification, transaction falsification, and the like. Thus, as seen in FIG. 1B, the assets are unable to be securitized. To the contrary, as seen in FIG. 2B, by placement of the assets on the blockchain, through digitization and verification, the assets are open, transparent, securitized and able to be traded on an asset-backed security market. As discussed below, through methods of the present invention, the number of assets, such as auto loans, as but one example, that can be securitized and traded can increase by a factor of 10 times or greater.

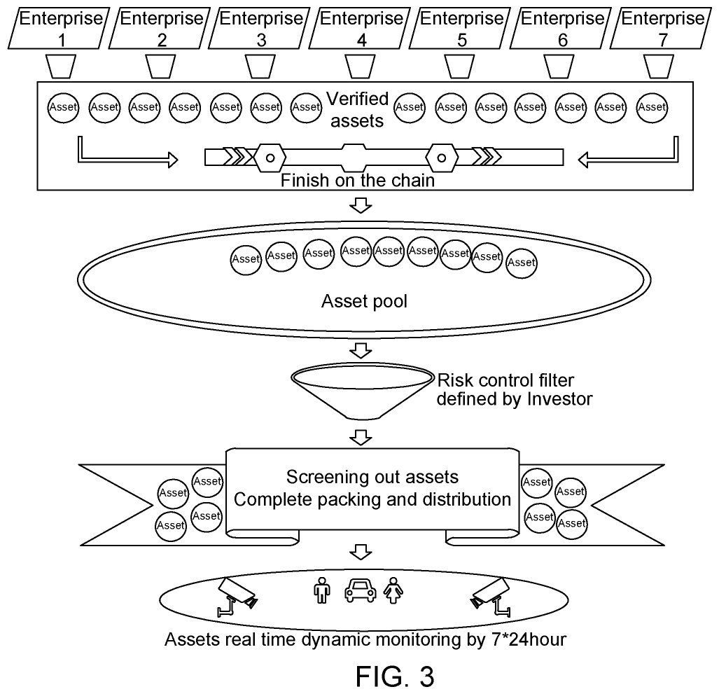

FIG. 3 illustrates how the methods of the present invention use blockchain to help enterprises pack assets and issue ABS. The methods of the present invention can be used to digitize enterprise assets and make them securitized. The methods of the present invention further establish a multi-level capital market to open up an innovative financing mode with blockchain packaging assets while adding new financing channels to enterprises with stable cash flow. This concept is referred to herein as asset-backed digitization and securitization (ABDS). As shown in FIG. 3, assets cannot be securitized by small and medium-sized enterprises in various industries. However, by using blockchain technology and the methods of the present invention, the assets can form an asset chain on the blockchain, providing digitized assets to form an asset pool. Information associated with the asset can be verified and also placed on the blockchain. Such information may include, for example, the identity of a lender or borrower, vehicle information verification, purchase invoice verification, insurance verification, comprehensive credit collection, vehicle asset evaluation, signing of an electronic contract, and the like. In some embodiments, such information may include the use of Internet of Things (JOT) technology to collect infrastructure project assets static and dynamic data to show the project history and status in real time. Any of this information may be considered dynamic information, where updates may be recorded on the blockchain and linked to the original information, allowing the asset to be easily reviewed and providing a strong asset suitable for packaging in an asset-backed security.

Under the supervision of the appropriate regulatory commissions, brokers can pack and issue asset-backed securities based on the digitized assets that were otherwise not available. In the end, the small and medium-sized enterprises can obtain appropriate financing through the monetization of their assets.

The advantages of using blockchain technology are several. For example, the digitized assets are of high transparency and strong liquidity. The methods of the present invention further provide credibility, efficiency, security, prevention of tampering and the like. The methods of the present invention can use blockchain, big data, Internet of Things (TOT) and other technologies to penetrate real underlying assets and verify the real assets on the blockchain at any time to ensure that assets are real and effective. Moreover, with methods of the present invention, buyers can view real-time and dynamic asset status and use asset dynamic monitoring to discover and avoid risks in time to ensure asset safety.

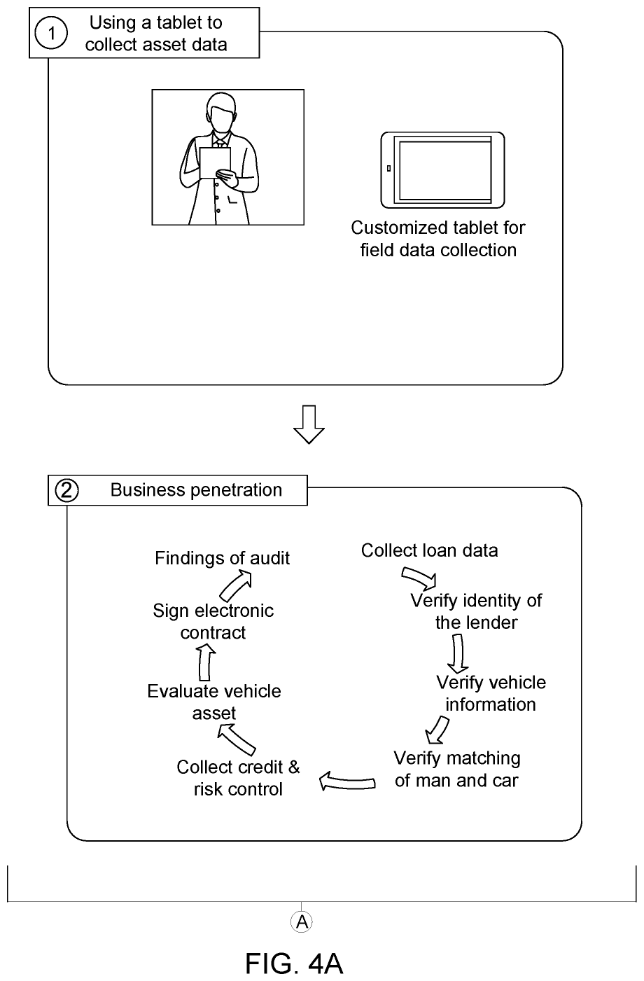

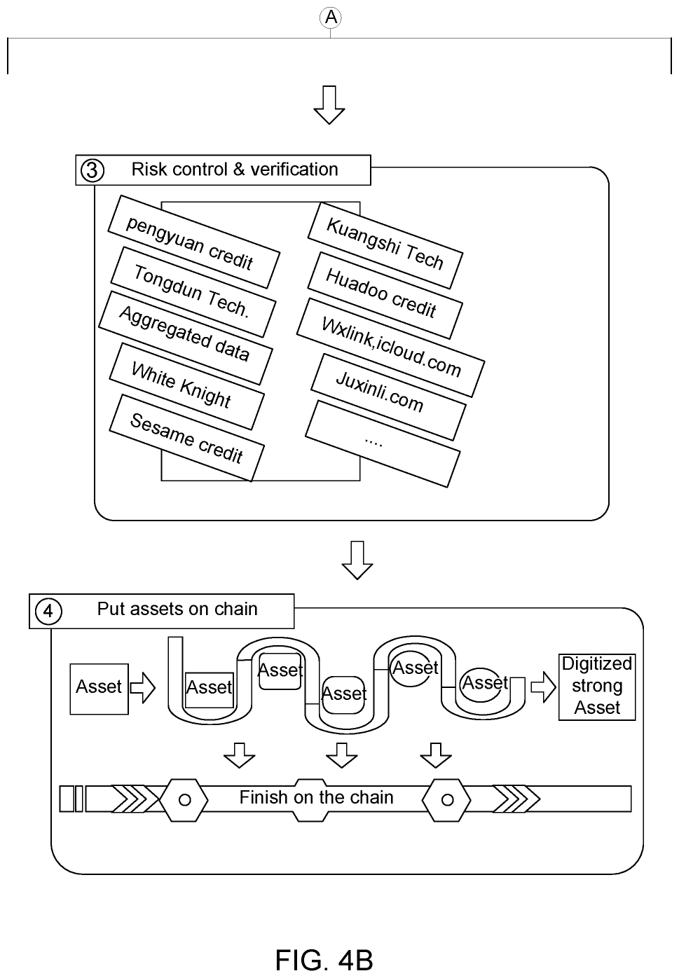

FIGS. 4A and 4B illustrate an exemplary process that may be used in the auto loan ABS markets. Through penetration of the underlying auto loan assets, multiple assets can be verified and used to complete the asset chain and then form an asset pool. While an auto loan is exemplified herein, the methods of the present invention may find application in a wide variety of assets, including but not limited to auto loan assets, infrastructure assets, real estate prospective earnings, education market prospective earnings, oil, gas and other natural resources markets, and the like.

Step 1 shows where a loan manager in the loan business can be equipped with a loan terminal. The loan terminal may be a computing device that may wirelessly transfer data, for example. In some embodiments, the loan terminal is custom tablet computing device which generates authoritative loan data.

Step 2 shows how the mobile computing device may be used to complete the full closed cycle of the loan transaction at anytime and any location. In some embodiments, the data collected in the loan process may be included as supporting data in the asset block to be placed on the blockchain, providing a verifiable and transparent asset. The full closed cycle of the loan transaction can include, for example, the following steps: collect loan data; verify identity of the lender; verify vehicle information; verify matching of lender and vehicle; collect credit and risk control information; evaluate vehicle asset; sign electronic contract; and findings of audit.

Step 3 shows examples of authoritative third-party platforms through official verification of pages, databases and the like, that can be used to complete the credit verification. Various rick control mechanisms, multiple cross-checks and verification of the assets can be included in this step. The risk control and verification data may be included in the details of the asset as placed on the blockchain. While specific examples of external data are shown, it should be understood that other third-party platforms, databases, or the like may be used as appropriate for the industry, the physical location (country) of the transaction, or the like.

In step 4, the asset, including the information collected in steps 2 and 3 above, may be placed on the blockchain, where business process data can be kept step-by-step and stored in blocks and put on the blockchain. The result is a strong and safe digitized asset with real, highly transparent and authoritative public trust that cannot be altered or tampered with.

While the above has use the auto loan industry as an example, the methods of the present invention may be applied to other industries. Another such example is the use of the methods of the present invention for real estate asset digitization and placement on the blockchain using IOT technology.

In this embodiment, a first step can include setting up IOT equipment according to the funding party's requirements. This equipment may be used in real estate such as buildings, merchants, factories, parking lots and the like.

A next step can include collecting static and dynamic data. The static data can reflect the real asset, such as the physical information of the asset, the contract for the project, the future rights and interests about the real estate, and the like. The dynamic data, that can be collected using the IOT equipment set up in the first step, can reflect the current status of the assets and provide up-to-date information about the assets to the investors. IOT devices can collect dynamic data such as the number of personnel passing through a building entrance, cargo loading status, parking usage, electricity and water consumption, and the like, which, taken together, provide a rich picture of asset health. This data can also help deter false claims about the asset health.

A further step can include a data verification step, where, the data collected can undergo a verification process to make sure the data are real and reasonable. If the data contains personnel information, it may be verified through an authorized population database, for example. If the data is about real estate, it may be verified by an appropriate real estate bureau, for example. The data collected by IOT devices can be cross-checked in multiple ways to eliminate single data error.

Once the data is verified, the collected data and the details of the verification process may be stored in blocks and put on the blockchain. Those data form strong and safe digitized assets with real, highly transparent and authoritative public trust that no one can tamper with.

Conventional methods pose two primary problems. First, the data about the assets was static and did not accurately reflect the current status of the asset. The methods of the present invention continue to track the status of the asset and record data in the blockchain that is linked to the original data. This provides greater trust about the current value of the asset. Second, the conventional business process data was usually stored in a central database, which may have the risk of database owner manipulation of data. With the methods of the present invention, the data may be placed on the blockchain, which ensures that no player can modify the data without consensus from others.

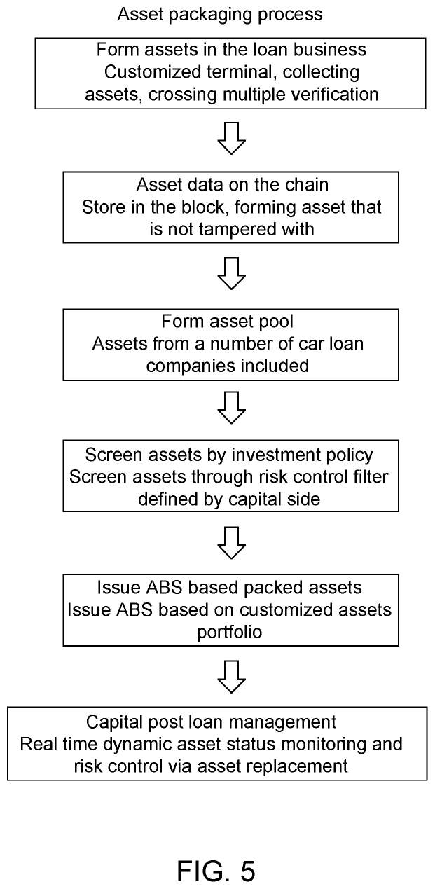

FIG. 5 shows an exemplary asset packaging process, summarizing much of the above described methods. The assets may be formed in various industries. The auto loan process is described specifically in FIG. 5, where the loan information may be collected and cross multiple verification steps. The asset data is placed on the blockchain and an asset pool can be formed, where the asset pool may include assets from one or more various enterprises. The assets may be screened by a risk control filter and the ABS based packed assets may be issued based on a customized asset portfolio. Finally, as shown in the last step of FIG. 5, capital post-loan management can include real-time dynamic asset status monitoring and risk control for asset lossless replacement, which will be discussed in greater detail below.

Through the block on the chain, the investor can trace the data when assets were generated, such as the details of each asset, the credit report, the verification results of the purchaser and vehicle, the contract, and the like. When the assets are packaged, the assets can be screened according to the customized risk control models such as region, credit reporting, age, household registration, vehicle valuation and the like.

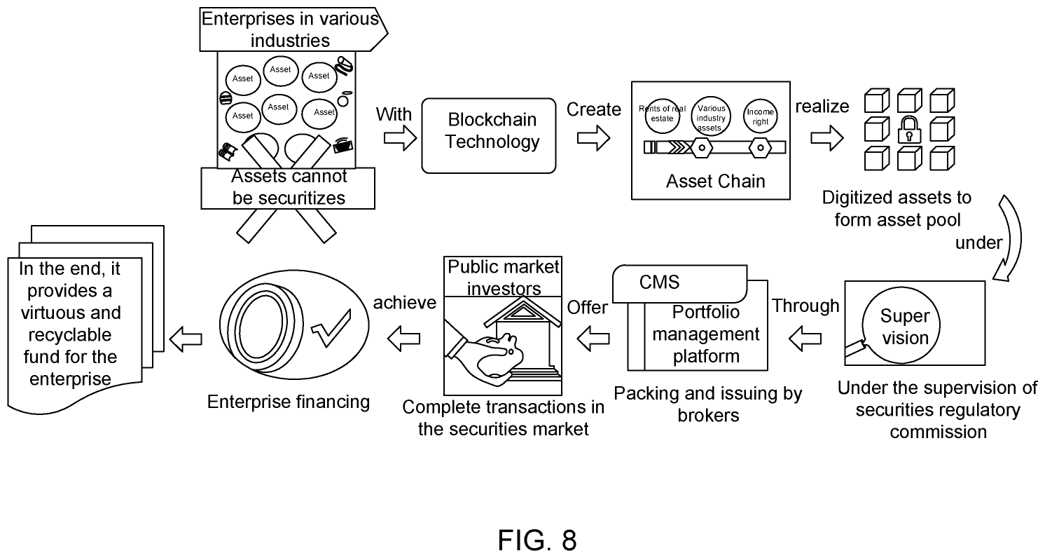

Referring to FIG. 8, an exemplary asset packaging operation is illustrated. Below details the workflow in building a dynamic asset package. One step involved in creating a dynamic asset package according to an exemplary embodiment of the present invention is to establish an asset pool. Following a process specific to a given industry, data can be collected about the assets and this data can be recorded on the blockchain to digitize each asset, as discussed in greater detail above. For example, in the auto loan business, using a hardened tablet (that is, a tablet specifically adapted for use with systems and methods of the present invention) in the field, auto loan business data can be gathered, including lender credit and verification information, vehicle information and the electronic contract. This information can be recorded on the blockchain to become an auto loan digitized asset. This process can be repeated across a wide collection of assets, thus forming an extensive asset pool. In each auto loan company, the pool can contain many auto loan assets to reflect a real auto loan business. Once the pool is established, a dynamic package can be set up in the next step.

At this stage, the assets in the asset pool can have different qualities as reflected by the credit information recorded about them. For example, in the auto loan business, the lenders from tier one cities in China (such as Beijing, Shanghai, Guangzhou and Shenzhen) may have higher credit than people in other cities because tier one cities have better control over auto license places. To create a high-quality package, the capital side (investor(s)) can define the requirement and selection criteria with respect to each industry to screen assets from the pool and then put the selected assets into the asset package to form a dynamic asset package. This selection criteria may be predetermined by the investor(s) to meet a certain threshold for credit worthiness, for example. However, such criteria may be flexible and depend on the particular investors, the particular industry, or the like.

The dynamic asset package can be continuously maintained to keep the assets' quality. With an appropriately maintained extensive pool of assets, methods of the present invention make available good candidates to replace bad assets in various packages, allowing the ability to reliably maintain packages at the expected quality. The methods of the present invention can manage the asset pool and the associated packages such that the expected flow of new assets (new business) will be sufficient to maintain the quality of the defined packages. As long as there is new business, generating new assets can be continuously added so that the asset pool can contain new good assets, the dynamic asset package will be in good quality and the risk for securitization will be much lower than static asset packages.

The dynamic package format can be used as described above to maintain overall package quality. In some embodiments, the methods of the present invention may be used to progressively collect more and more assets together over time, perhaps as those assets are being created, with rules determining when the package is considered complete, and a new package should be started.

Conventionally, the asset package is static, which means the set of assets in the package is fixed. One cannot select only the good quality assets from the package for ABS—one must select all or nothing. With the methods of the present invention, several asset pools may be established, where good quality assets are screened out into a dynamic package. The package can undergo continual maintenance by replacing those assets which become bad. In the end, the methods of the present invention can greatly reduce the risk of bad assets in the ABS. As discussed above with respect to FIGS. 2A through 2C, the methods of the present invention create ABS that does not rely on the strength of the enterprise of the credit worthiness of the enterprise. Instead, the methods of the present invention create ABS that relies on the formation of strong, transparent, verified assets.

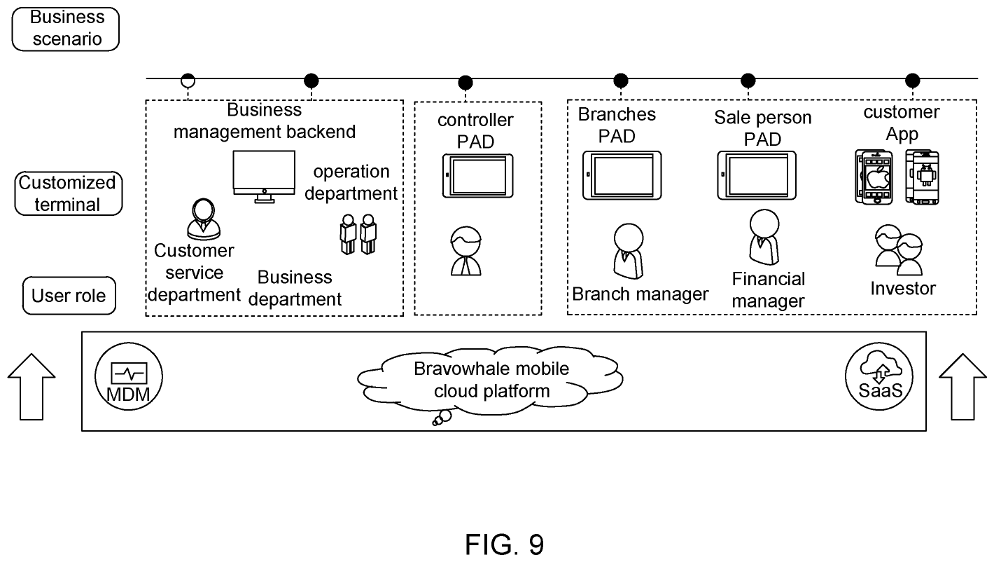

Referring to FIG. 9, embodiments of the present invention provide a mobile cloud platform for financial and other high-end service enterprises. The mobile cloud platform may service various business scenarios, including customer visit, information review, customer management, product management, event publication, order review, statistical analysis, process management, performance statistics, performance ranking, KPI management, product display, marketing activities display, self-service business handling inquiries, customer information collection, image data uploading, product activity display, business product learning, business reservation, activity registration, revenue query, push message reminder, and the like. Through professional customized mobile terminals, embodiments of the present invention can provide a mobile cloud platform for exhibiting industry transactions.

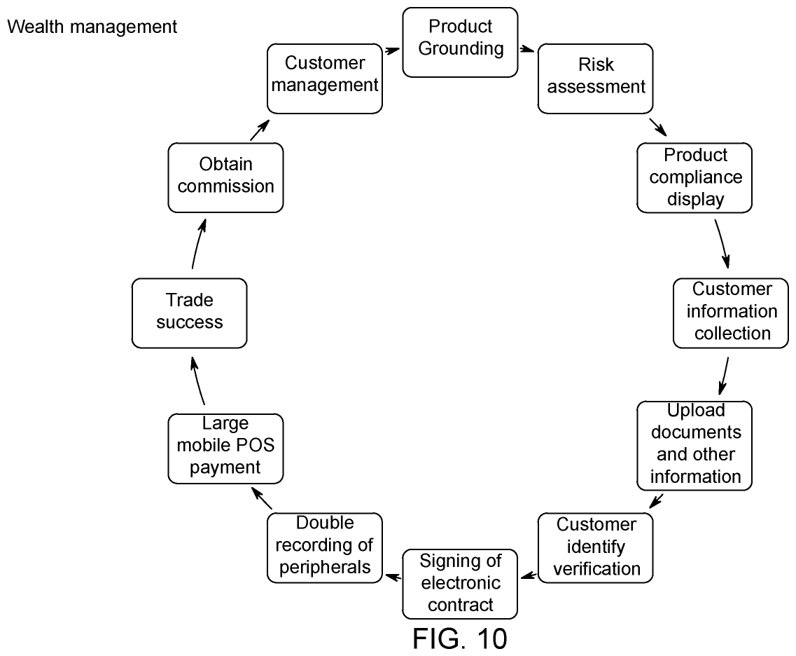

Referring to FIG. 10, the mobile cloud platform usable in embodiments of the present invention can provide a mobile financial transaction personal application device (PAD). FIG. 10 shows some examples of various applications usable on the PAD. For example, as discussed above with respect to auto loans, the PAD may be used to collect customer information, upload documents for assembly into blocks for placement on a blockchain, perform verifications, obtain a signature on a contract, or the like.

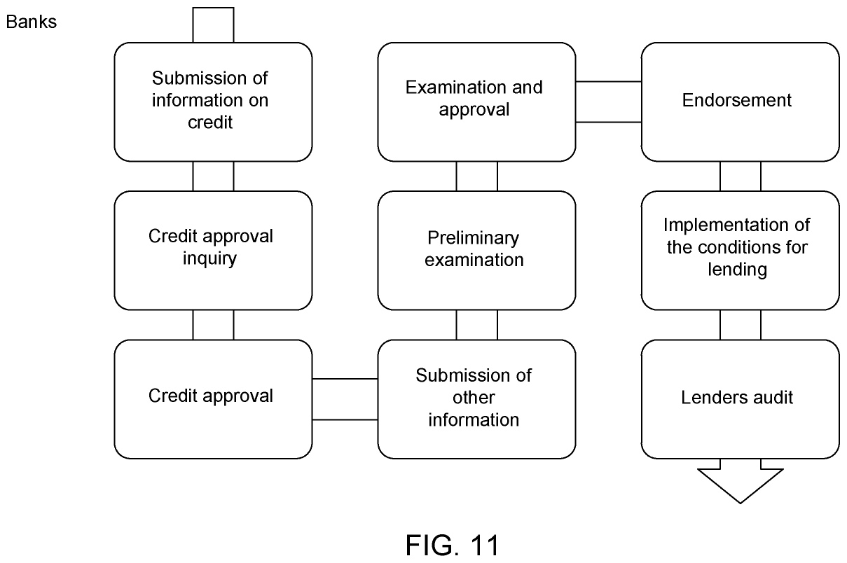

Similarly, FIG. 11 illustrates a flow chart for banks to use the mobile cloud platform of the present invention for, as an example, a consumer loan application process. These processes may be incorporated into embodiments of the present invention, as discussed above, to provide workflows for the collection and review of data that may be placed on the blockchain to provide strong financial assets.

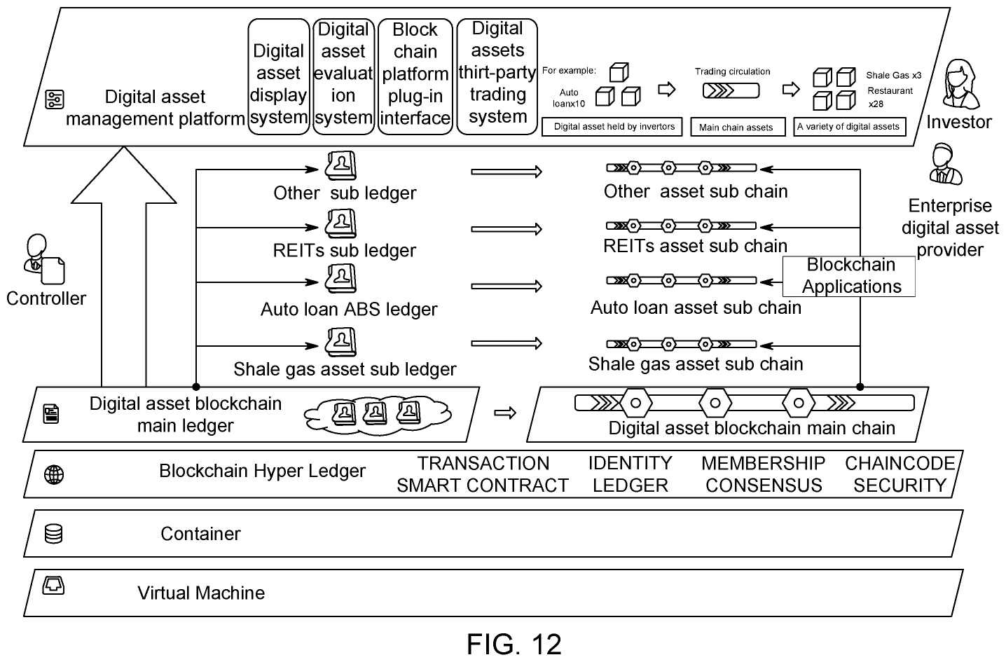

FIG. 12 illustrates on possible digital asset blockchain ecological platform architecture according to an exemplary embodiment of the present invention. There is shown a digital asset management platform that may include an asset display system, an asset evaluation system, a blockchain platform plug-in interface and an assets third-party trading system. FIG. 12 illustrates an example of how various assets on various ledgers may be placed on blockchain sub chains and be linked to the blockchain main chain. In some embodiments, each of the sub chains may relate to a particular industry, such as real estate, auto loans, shale gas, and the like. Of course, the embodiments of the methods of the present invention described above are not limited to any specific platform architecture and that shown in FIG. 12 exemplifies but one possible platform architecture usable in certain embodiments of the present invention.

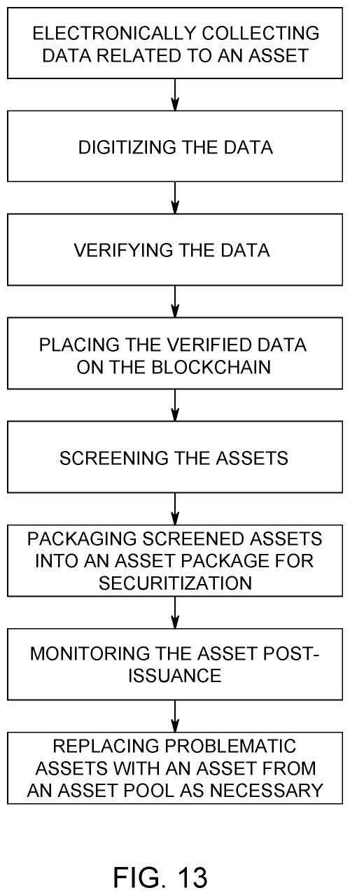

FIG. 13 provides an overall summary, illustrating various aspects of the present invention. It should be understood that the invention is defined by the claims and does not require all of the recited method steps, does not require the methods steps be performed in any specific order, and may include additional steps as described herein. The asset data may be collected wherein the asset data required for collection may vary depending on the specific industry, requirements of the investor, or the like. In some embodiments, a customized tablet computer may be used for asset collection.

Once the data is collected, the data may be digitized and verified. The verification, as discussed above, can include the use of third-party platforms, the Internet of Things, public and private databases, or the like. In some embodiments, the verification data, or a portion thereof, may be digitized for placement on the blockchain.

The assets may then be screened on various factors, including those requirements provided by any investors. At least a portion of the screened assets may be used to be packaged into an asset package for securitization. Other assets, either those screened or those that have not been screened, may be used to replace problematic assets in the asset pool, thereby creating a dynamic asset package.

While the above description refers to certain asset backed securities, it should be understood that the term “asset-backed security” and “asset backed digitization and securitization” may include any security that is based on transparent data and monitoring and which may be put onto blockchain. Thus, the methods of the present invention contemplate the use various assets as may be understood in the art.

### EXAMPLES

While the methods of the present invention may be applied to various industries as discussed above, the specification below describes specific examples through which methods of the present invention may be particularly applicable. It should be understood that the present invention, as defined by the patent claims, are not limited by any specific disclosure described below nor should any of the specifics of the examples below be interpreted to limit the meaning of any claim terminology.

A. Auto Loan Assets

Embodiments of the present invention may be readily implemented in one vertical industry—the auto loan business. Embodiments of the present invention can enable investors to assess the value of auto loan assets and thus make auto loans amendable to asset-backed securitization. As described in greater detail below, embodiments of the present invention can digitize the auto loan business process, thus creating a dynamically updated digital asset. Methods of the present invention can record the results using blockchain technology to enable a set of industry players to trust the data, including auto loan companies, investors and others. A selection of the assets can be packed together to form a digital asset package amenable to financing and exchange/trading (as asset-backed security). Methods of the present invention can open the door to financing auto loan enterprises from the public offering market, solving financing issues for auto loan companies.

Referring to FIGS. 3 through 7, a specific example of the use of the methods of the present invention in the auto loan industry is described.

A first aspect of the methods of the present invention involve bringing assets onto the blockchain. As discussed above, the present invention provides technical means to digitize the assets. For the auto loan industry, embodiments of the present invention can use a customized tablet in the field to collect details of auto loan assets and upload to an auto loan business process system. The representatives from auto loan companies can use the tablet to generate auto loan business. They can complete the full closed cycle of the loan transaction at anytime and anywhere through the customized tablet. To ensure trusted and high-quality data, the following information can be verified via third parties, and the results of the verification can be put onto the blockchain. Thus, the transaction will be real and cannot be tampered with. This data can include, for example, the identity of the lender, vehicle information verification, purchase invoice verification, insurance verification, comprehensive credit collection, vehicle asset evaluation and the signing of an electronic sales contract. This set of transaction data constitutes the auto loan asset.

Once the assets are on the blockchain, methods of the present invention can pack an asset package. More transactions mean more assets, and the multiple assets can become an asset pool. Based on the selection criteria from financial providers (such as an ABS issue broker, for example), high quality assets can be screened from the asset pool to form a dynamic asset package. This package will support a reliable and managed-risk asset backed securitization.

Once the verified assets are packaged to form the dynamic asset package, the methods of the present invention can issue the ABS or auto loan finance product. Based on the dynamic asset package, an ABS broker can be used to issue the ABS. In an alternate embodiment, a financial group can be used to issue a finance product based on the auto loan assets.

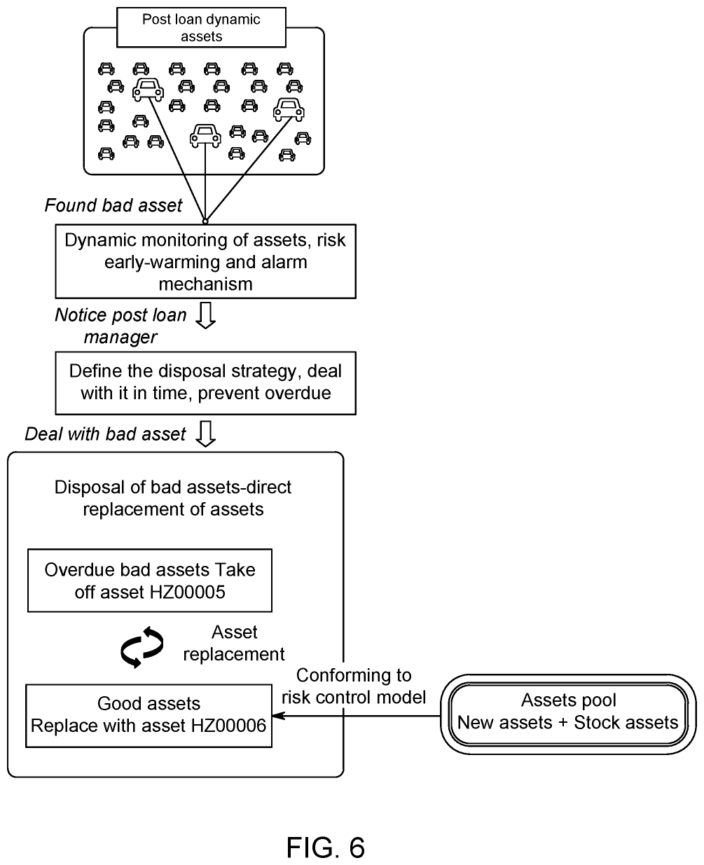

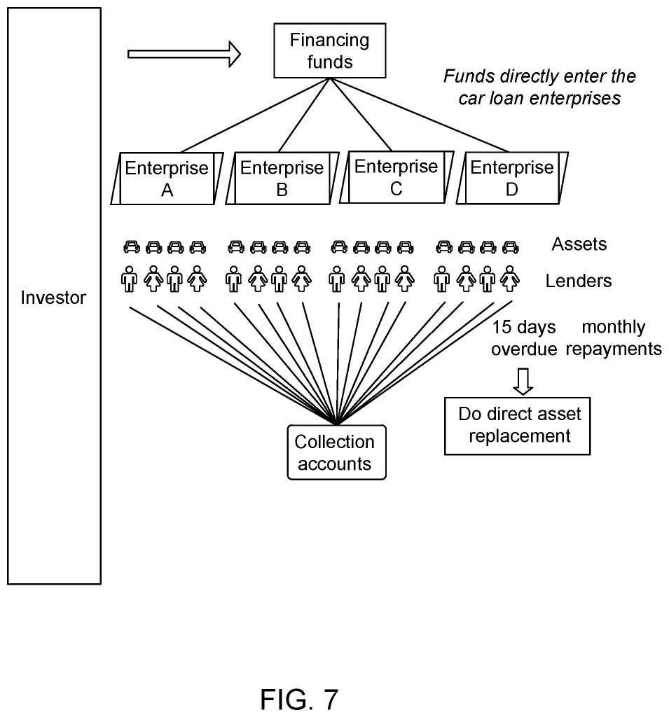

Finally, as discussed generally above and as shown in FIGS. 6 and 7, methods of the present invention provide post-issue management of the ABS.

After issuing an ABS or auto loan finance product, methods of the present invention help brokers or financial institutes to replace bad assets with new generated assets from continuing new business, allowing the methods to reliably maintain packages at the expected quality. Methods of the present invention can manage the pool and packages such that the expected flow of new assets (new business) will be sufficient to maintain the quality of the defined packages. In the meanwhile, methods of the present invention can manage the capital to ensure the money is used safely and in the proper purpose through escrow. From the management of both asset side and capital side, methods of the present invention can reduce the risk in whole process of ABDS.

For example, methods of the present invention provide for the identification of bad assets. Various mechanisms may be utilized for this identification process, including equipment GPS monitoring, behavior trajectory monitoring, special area electronic fence alarm, real-time credit monitoring and credit downgrade warning, and the like.

A notice may be provided to the loan manager in order to attempt to rectify any issues with any individual assets. This helps prevent a potentially bad asset from turning into a bad asset that needs replacement. Finally, should the issues found with an asset not be rectified, the asset may be replaced with an asset from the asset pool, as discussed above. Should a new loan asset not be available, a cash or stock replacement may be utilized, either temporarily or permanently, as part of the asset package, thereby maintaining the quality of the ABS.

In summary, with the solution provided by the methods of the present invention, ABS issue broker or investors can access (and thus assess) the underlying data about the assets, which reflects auto loan asset status. Auto loan asset bundles can be maintained with consistent quality by replacing non-performing assets. The individual (e.g., monthly) loan repayment installments for each asset can be monitored to evaluate the quality of the asset. Also, the capital can be managed to make sure the money is used for new auto loan business through escrow. Investors have a new source of data for assessing risk of auto loan assets. Through embodiments of the present invention, a vastly greater fraction, up to 80%, of loan assets, can become amenable to ABS and a pool of monitored auto loan assets exists, where none did before.

B. Utility Infrastructure Assets

This example provides an implementation of ABDS (Asset Backed Digitization and Securitization) in another vertical industry—the utility infrastructure industry. Embodiments of the present invention can enable investors to assess the value of the utility infrastructure asset and thus make utility infrastructure amenable to financing through vehicles such as ABS. Methods of the present invention can digitize the utility infrastructure assets, thus creating a dynamically updatable digital asset. Methods of the present invention can record the results using blockchain technology to enable a set of industry players to trust the data, including infrastructure development companies, utility operators, investors and others. The digital asset may be used as-is or may be split to smaller portions amenable to financing and exchange/trading. Embodiments of the present invention can open the door to financing utility infrastructure enterprises from the public offering market, solving financing issues for large utility infrastructure business.

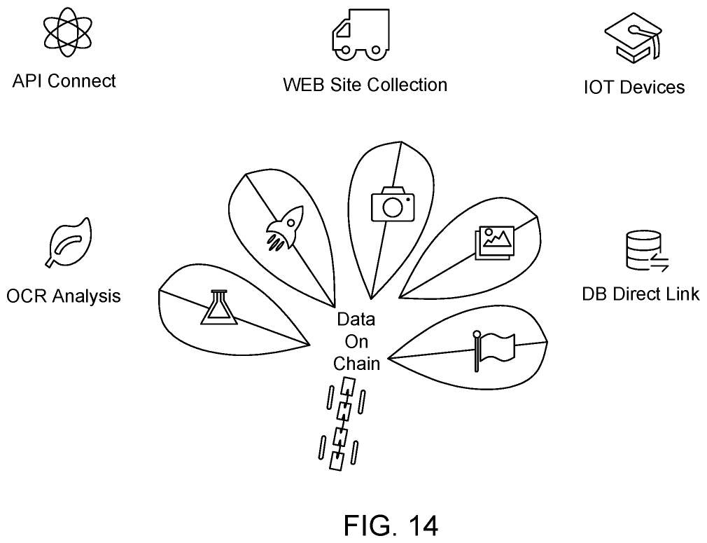

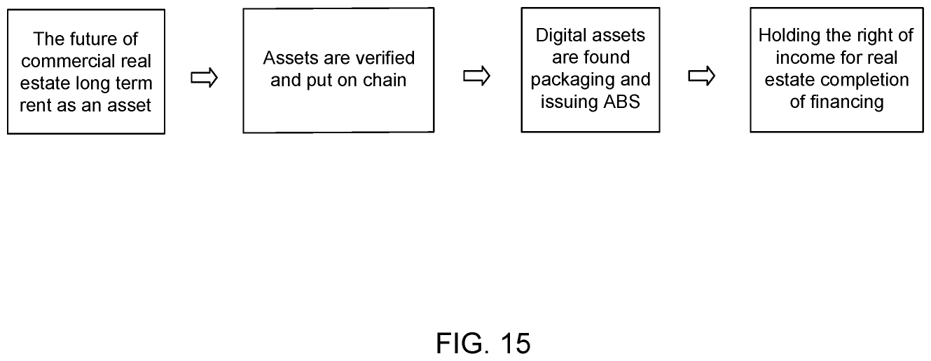

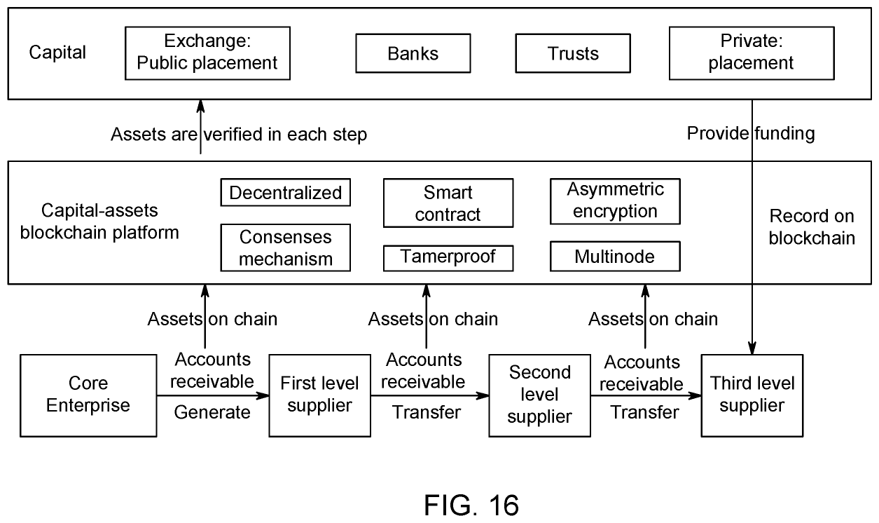

Referring to FIG. 14, a specific example of the use of the methods of the present invention in the utility infrastructure asset industry is described.

A first aspect of the methods of the present invention involve the collection of static and dynamic data for utility infrastructure assets. Aspects of the present invention provide the technical means to digitize the assets. The methods of the present invention can use several technologies, such as API connect (for providing real-time dynamic data with API seamless connection), WEB Sites collections (for real-time crawling and updating of distributed web sites), IOT devices (for the collection, analysis and management of data generated by Internet of Things equipment), OCR analysis (for the intelligent recognition of text content in pdf files and pictures) and database direct link (for independent collection, reducing the cooperation of the original software vendors) to collect details of utility infrastructure assets and upload to a backend utility infrastructure business system.

For example, below is data collection for a shale gas power generation project. This data includes static data from OCR Analysis, where the result can be verified by domain experts. This static data includes: 1. Project government planning approval data; 2. Natural resources and Environmental Assessment Report; 3. Land requisition property and approval document of power plant; 4. Construction drawings and instructions for the first edition of the project; 5. Project construction start plan and implement plan; 6. Contract information on project construction; 7. Organization material and equipment order agreement and voucher; 8. Purchase agreement of equipment and material; 9. Shale gas survey report from gas supply company; 10. Steam sale agreement; 11. Phase purchase contract from purchasing power company; 12. Confirmation of bank loan approval; 13. Examination and approval certificate of contract law firm signed for the project; 14. Risk withdrawal mechanism; and 15. Risk repurchase point.

The data collection can further include static data from WEB sites, such as the following: 1. Proof of commencement conditions such as water, electricity and road; 2. Introduction to enterprise background and large project experience; 3. Project designer and construction engineer data; 4. Introduction and project experience of supervision company; 5. Government purchase agreement of power plant; 6. Power purchase agreement and credit rating certification; 7. Power Market Forecast Report; 8. Co-supplier information of the construction company; 9. Qualification rating and filing inquiries of law firms; 10. Supplier project cooperation open report data query; and 11. Third party rating query method for each contractor.

The data collection can also include dynamic data through API Connection, such as the following: 1. Annual profit and tax data of power plant operation; 2. Electricity daily production data; 3. Shale gas income and usage data in power plant; 4. Operating income, operating costs, business tax, business expenses, management expenses, and financial expenses; 5. Synchronous platform for project construction progress; 6. Project account payment; 7. Large payment schedule inquiry method; 8. Cost of environmental pollution treatment; and 9. Third party rating result for each contractor.

The data collection can also include dynamic data from a DB direct link, such as the following: 1. Electronic record of machine maintenance and maintenance operation ticket; 2. Daily machine operation tickets for centralized control, electrical, gas, boiler, and the like; 3. Operation records of various switching operations of electric system, synchronization network and generator transformer unit; and 4. Electronic record of machine anomaly and fault alarm.

The data collection can also include dynamic data from IOT devices, such as the following: 1. Power consumption data of power plant; 2. Day-to-day motor start ignition record; 3. Real-time speed detection data of motor; 4. Real-time monitoring of lubricating system data; 5. Real time monitoring of air pressure system; 6. Real-time monitoring of cooling system data; and 7. Real-time detection of gas emission data.

Once the data is collected, the methods of the present invention provide for the verification and analysis of collected data, followed by the upload of utility infrastructure assets on blockchain. After collection of the data, third party domain experts or investment banks can help to verify the data, do analysis and give the reporting to investors. Both static and dynamic data, as well as the reporting, can be uploaded into blockchain. This will digitize the asset with ongoing data that cannot be tampered with. The investors can check the project status at any time and can see the up-to-date information about the asset in the dashboard.

Once the data is verified and uploaded into the blockchain, the methods of the present invention can issue an ABS or utility infrastructure finance product. Based on the dynamic asset package, an ABS broker can issue and ABS. Alternatively, a financial group can be used to issue a finance product based on the utility infrastructure assets. For the finance product, if it is needed, the asset could be split into smaller portions. For example, if the utility infrastructure asset is a USD 50M project, methods of the present invention can split it to 5000 pieces, with each worth 10K, bringing it within reach of more investors. This will increase the possibility to issue the finance product to public markets.

Finally, once the ABS or finance product is issued, as discussed above, the methods of the present invention can perform post-issue management. After issuing an ABS or utility infrastructure finance product, methods of the present invention can help brokers or financial institutes to monitor the asset by continuing to collect dynamic data and upload the data to the blockchain, and provide investors with an electronic dashboard to check the asset status. In some embodiments, methods of the present invention can provide for the trading of the finance product with assets.

In summary, with the solution provided by this aspect of the present invention, ABS issue brokers or investors can access (and thus assess) the underlying data about the assets, which reflects utility infrastructure asset status. The invest-and-return analysis can be done based on real utility infrastructure asset data, thus utility infrastructure asset can be seen as a high-quality asset by investors. Further, large utility infrastructure assets can be split into small portions for individual investors.

C. Real Estate Prospective Earnings

This example provides an implementation of ABDS (Asset Backed Digitization and Securitization) in another vertical industry—the real estate industry. Embodiments of the present invention can enable investors to assess the value of real estate prospective earning assets (also referred to as real estate future cash flow assets) and thus make real estate prospective earnings amenable to ABS. Methods of the present invention digitize the process of the real estate business such as housing loan, parking space rental, business property rental and the like, thus creating a dynamically updated digital asset. Methods of the present invention can record the results using blockchain technology to enable a set of industry players to trust the data, including real estate companies, investors and others. Methods of the present invention can then pack a selection of assets to form a digital asset package amenable to financing and exchange/trading. Embodiments of the present invention can open the door to financing real estate enterprises from the public offering market, solving financing issues for real estate industry.

A first aspect of the methods of the present invention involve bringing assets onto the blockchain. As discussed above, the present invention provides technical means to digitize the assets. In most cases, depending on the type of real estate business, methods of the present invention can use two ways to digitized the assets. First, a customized tablet may be used and, second, linkage technologies may be used, such as IOT devices, OCR analysis and API connect.

In the housing loan business, embodiments of the present invention can use a customized tablet in the field to collect details of housing loan assets and upload to a backend housing loan business process system. The representatives from housing loan companies can use the tablet to do business. They can complete the full closed cycle of the loan transaction at anytime and anywhere through the tablet. To ensure trusted and high-quality data, the following information can be verified via third parties, and the result of the verification can be put onto the blockchain. Thus, the digital asset is both verified and cannot be tampered with. The data includes the following: the identity of the lender; house information verification; purchase invoice verification; insurance verification; comprehensive credit report; house asset evaluation (aka appraisal); and the signing of an electronic contract. This set of transaction data constitutes the housing loan asset.

In parking space rental or property rental business, methods of the present invention can use linkage technologies, such as OCR analysis and API connect/IOT devices, to collect both static and dynamic data for the details of the real estate rental assets and upload the data to a backend real estate business system. For example, the data collection for a parking space rental data is as follows:

(1) Static data from OCR Analysis, including (a) land requisition property and approval document; (b) parking space government approval data; (c) construction drawings and instructions for the first edition of the parking space; (d) contract information on project construction; (e) construction start plan and implement plan; (f) parking space general information document, such as map, location, area; and (g) each parking space detail information document, such as position, area; and
(2) Dynamic data through API Connection and IOT Devices, including (a) daily parking operation data for each space; (b) daily parking statistics data; (c) monthly profit and tax data of parking business; (d) power consumption data for parking area; (e) operating income, operating costs, business tax, business expenses, management expenses, and financial expenses; and (f) parking system maintenance operation records.

The data can be verified by third party domain experts to check the reliability, and each parking area can be identified as a separate asset. After the asset data is digitized, the data can be uploaded into blockchain.

After the data is uploaded on the blockchain, methods of the present invention can pack the asset package. More transactions mean more assets, and the assets become an asset pool. Based on the selection criteria from financial providers (such as an ABS issue broker), high quality assets can be screened from the asset pool to form a dynamic asset package. This package can support a reliable and managed-risk asset backed securitization.

Once the assets are packaged, methods of the present invention can issue an ABS or real estate prospective earning finance product. Based on the dynamic asset package, an ABS broker can issue an ABS. Alternatively, a financial group can issue a finance product based on the real estate prospective earning assets.

Methods of the present invention provide support beyond the issuance of the ABS or finance product through post-issue management. After issuing an ABS or real estate prospective earning finance product, methods of the present invention can be used to help brokers or financial institutes to replace bad assets within a package with new generated assets from continuing new business, allowing the reliable maintenance of packages at the expected quality. Methods of the present invention can manage the asset pool and asset packages such that the expected flow of new assets (new business) will be sufficient to maintain the quality of the defined packages. In the meanwhile, methods of the present invention can manage the capital to ensure the money is used safely and in the proper purpose through escrow. From the management of both asset side and capital side, methods of the present invention will reduce the risk in whole process of ABDS.

In summary, with the solution provided by embodiments of the present invention, ABS issue broker or investors can access (and thus assess) the underlying data about the assets, which reflects real estate prospective earning asset status. Real estate prospective earning asset bundles can be maintained with consistent quality by replacing non-performing assets. The individual (e.g., monthly) loan repayment installments for each asset can be monitored to evaluate the quality of the asset. Also, the capital can be managed to make sure the money is used for new real estate business through escrow. Investors have a new source of data for assessing risk of real estate prospective earning assets. Methods of the present invention can provide a vastly greater fraction, up to 80%, of real estate prospective earning assets, that will become amenable to ABS and a pool of monitored real estate prospective earning assets exists, where no such pool existed before.

D. Supplier Account Receivable

This example provides an implementation of ABDS (Asset Backed Digitization and Securitization) in another vertical industry—the supply chain industry, especially for supply chain finance. Embodiments of the present invention can enable investors to assess the value of supplier account receivable assets and thus make supplier account receivable amenable to ABS. Methods of the present invention can digitize the process of supplier account receivable business, thus creating a dynamically updated digital asset. Methods of the present invention can record the results using blockchain technology, to enable a set of industry players to trust the data, including supplier companies, core enterprises in supply chain, finance companies, investors and others. Methods of the present invention can then pack a selection of assets to form a digital asset package amenable to financing and exchange/trading. Embodiments of the present invention can open the door to financing supplier enterprises from the public offering market, solving financing issues for supply chain industry.

A first aspect of the methods of the present invention involve bringing assets onto the blockchain. As discussed above, the present invention provides technical means to digitize the assets. In most cases, methods of the present invention use two ways to digitize the assets for supplier account receivable business: (1) A customized tablet; and (2) Linkage technologies, such as IOT devices, OCR analysis and API connect.

Embodiments of the present invention can use a hardened tablet in the field to collect details of supplier account receivable assets and upload to a backend supply chain business process system. The representatives from supplier companies can use the tablet to do business. They can complete the full closed cycle of the transaction at anytime and anywhere through the tablet. To ensure trusted and high-quality data, the following information can be verified via third parties, and the verification result can be put onto the blockchain. Thus, the digital asset is both verified and cannot be tampered with. The data can include, for example, the following: payer information verification; receiver information verification; purchase invoice verification; insurance verification; comprehensive credit report; and the signing of an electronic contract.

Embodiments of the present invention can also use linkage technologies, such as OCR analysis and API connect/IOT devices, to collect both static and dynamic data for the details of supplier account receivable assets and upload to our backend supply chain business system.

Below are some sample data to be collected. The sample data can include static data from OCR Analysis, such as the following: 1. enterprise business license; 2. leasing contract; 3. proof of ownership; 4. right of operation and right to use proof document; and 5. advanced payment proof document. The sample data can also include dynamic data through API Connection and IOT Devices, such as the following: 1. daily operation information in supply chain business flow; 2. daily information in supply chain logistics; and 3. daily information in supply chain capital flow. The data can be verified by third party domain experts to check the reliability. After the asset is digitized, the data can be uploaded into blockchain.

After the data is uploaded on the blockchain, methods of the present invention can be used to pack an asset package. More transactions mean more assets, and the assets become an asset pool. Based on the selection criteria from financial providers (such as an ABS issue broker), high quality assets can be screened from the asset pool and then used to form a dynamic asset package. This package can support a reliable and managed-risk asset backed securitization.

Once the asset package is formed, methods of the present invention can be used to issue an ABS or supplier account receivable finance product. Based on the dynamic asset package, an ABS broker can be used to issue an ABS. Alternatively, a financial group can be used to issue a finance product based on the supplier account receivable assets.

Methods of the present invention provide support beyond the issuance of the ABS or supplier account receivable finance product through post-issue management. After issuing an ABS or supplier account receivable finance product, the methods of the present invention can be used to help brokers or financial institutes to replace bad assets within a package with newly generated assets from continuing new business, allowing the reliable maintenance of the packages at the expected quality. Methods of the present invention can manage the asset pool and asset packages such that the expected flow of new assets (new business) will be sufficient to maintain the quality of the defined packages. In the meanwhile, methods of the present invention can manage the capital to ensure the money is used safely and in the proper purpose through escrow. From the management of both asset side and capital side, aspects of the present invention will reduce the risk in whole process of ABDS.

In summary, with the solutions provided by embodiments of the present invention, ABS issue brokers or investors can access (and thus assess) the underlying data about the assets, which reflects supplier account receivable asset status. Supplier account receivable asset bundles can be maintained with consistent quality by replacing non-performing assets. Also, the capital can be managed to make sure the money is used for new supply chain business through escrow. Investors have a new source of data for assessing risk of supplier account receivable assets. Methods of the present invention allow a vastly greater fraction, up to 80%, of supplier account receivable assets, to become amenable to ABS and provide a pool of monitored supplier account receivable assets exists, where no such pool existed before.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a sub combination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

1. A dynamic asset package comprising:
a plurality of assets forming an asset package; and
an asset pool of assets, wherein
an asset of the asset package is replaced with an asset of the asset pool when the asset of the asset package is determined to be problematic; and
each of the plurality of assets of the asset package are recorded on a blockchain, wherein
verified credit data regarding each of the plurality of assets forming the asset package is recorded on the blockchain.

2. The dynamic asset package of claim 1, wherein the asset pool of assets has a quality similar to the plurality of assets in the asset package.

3. The dynamic asset package of claim 1, wherein each of the plurality of assets forming the asset package are screened according to one or more criteria.

4. (canceled)

5. The dynamic asset package of claim 1, wherein assets from the asset pool that replace assets in the asset package are recorded on the blockchain.

6. The dynamic asset package of claim 1, wherein assets from the asset pool that replace assets in the asset package are screened to have a quality similar to the assets in the asset package.

7. An asset packaging process comprising:
creating an asset in a particular industry;
storing the asset on a blockchain;
creating an asset pool from a plurality of the assets;
screening the plurality of assets based on criteria to create screened assets;
creating an asset package from at least a portion of the screened assets; and
electronically verifying credit data related to the assets of the asset package and storing data reflecting the verification of the assets of the asset package on the blockchain.

8. The process of claim 7, further comprising retaining at least a portion of the assets as a non-packaged asset pool.

9. The process of claim 7, further comprising managing the asset package to maintain the value thereof.

10. The process of claim 8, further comprising replacing a problematic asset in the asset package with an asset from the non-packaged asset pool.

11. (canceled)

12. The process of claim 7, further comprising issuing an asset-backed security based on the asset package.

13. A method for building a dynamic asset package, comprising:
establishing an asset pool comprising a plurality of assets, wherein data collected on each of the plurality of assets are digitized and recorded on a blockchain;
screening each asset of the plurality of assets in the asset pool based on criteria to create a plurality of screened assets;
placing at least a portion of the plurality of screened assets into the dynamic asset package;
maintaining the dynamic asset package to maintain asset quality;
verifying credit data collected on each of the plurality of assets; and
recording additional data associated with the verification of credit data collected on each of the plurality of assets on the blockchain.

14. The method of claim 13, wherein the step of maintaining the dynamic asset package includes replacing problematic assets in the dynamic asset package with assets selected from the plurality of assets.

15. (canceled)

16. (canceled)
